(19) United States
(12) Patent Application Publication
(10) Pub. No.: US 2013/0060631 A1
(43) Pub. Date: Mar. 7, 2013

(54) AD CACHE MAINTENANCE METHODS AND APPARATUS

(71) Applicants: Mathew Scott Corson, Gillette, NJ (US); Vincent D. Park, Budd Lake, NJ (US); Arthur Stephens, Hazlet, NJ (US); Ranjith S. Jayaram, Cupertino, CA (US); Georgios Tsirtsis, London (GB); Michaela Vanderveen, Tracy, CA (US); Charles Cullen Childress, Austin, TX (US)

(72) Inventors: Mathew Scott Corson, Gillette, NJ (US); Vincent D. Park, Budd Lake, NJ (US); Arthur Stephens, Hazlet, NJ (US); Ranjith S. Jayaram, Cupertino, CA (US); Georgios Tsirtsis, London (GB); Michaela Vanderveen, Tracy, CA (US); Charles Cullen Childress, Austin, TX (US)

(21) Appl. No.: 13/226,712

(22) Filed: Sep. 7, 2011

(51) Int. Cl. G06F 15/167; G06Q 30/00

(52) U.S. Cl. 705/14.46; 709/213

(57) ABSTRACT

Methods and apparatus relating to ad cache maintenance, e.g., determining when ad cache replenishment should occur, replenishing ad cache content and/or updating the content of an ad cache, on a device which supports the presentation of advertisements (ads) are described. Signals are received by a first device including an ad cache. The signals are received from other devices, e.g., devices in the direct wireless communications range of the first device. Received signals are processed and provide context information, e.g., information about the surrounding, services available, stores in the region, etc., in which the first device receiving the signals is at a given point in time. Context information is stored. As new context information is generated from received signals the newly generated set of context information is compared to a previously generated set of context information. Changes in context information are detected and used in performing ad cache maintenance operations.

### FIELD

The present application relates to methods and apparatus for performing ad cache maintenance, e.g., determining when ad cache replenishment should occur, replenishing ad cache content and/or updating the content of an ad cache, on a device which supports the presentation of advertisements (ads).

### BACKGROUND

On many devices capable of displaying advertisements, often known simply as ads, ads are presented at what is sometimes referred to as a presentation opportunity which in many systems is an opportunity to display an ad. At each presentation opportunity one or more ads may be presented. For example, a web browser may present an ad with each web page being viewed. In such systems, the display of each new web page also provides a new ad presentation opportunity.

A presentation opportunity normally corresponds to one or more factors or “contexts” associated with the presentation opportunity. Thus each presentation opportunity is normally associated with a set of contexts. Examples of contexts which may be associated with an advertising opportunity include: a user profile; demographics of a user of the device which may present the ad; the set of discovery signals received from other devices that are in proximity to the device; the absolute location of the device; loyalty information corresponding to the user; and application(s) running on the device associated with the presentation opportunity.

Advertisers typically target their ads based on one or more of these contexts. For example, an advertiser may wish to target an ad at users who belong to a certain demographic or users who are near a particular retail store. Because advertisers are willing to pay more for delivering ads which are highly targeted, ad networks attempt to present ads that are targeted to the contexts at the time of the presentation opportunity and are thus likely to be relevant at that time.

The more information regarding the context relevant to an ad presentation opportunity that is available, the more likely a relevant ad targeted to the user can be selected. Normally the greater the ability to target an advertisement the more an advertiser is willing to pay for the ad presentation opportunity.

As the context associated with presentation opportunities changes and/or stored ads grow, the ability of a device to supply highly targeted and relevant ads from an ad cache may diminish unless the ad cache contents are updated. Thus, while a device may store ads in an ad cache, it should be appreciated that the ad cache will need to be replenished at some point in time.

In view of the above discussion, it should be appreciated that there is a need for methods and/or apparatus relating to the replenishment of ad cache content on a device. In particular there is a need for methods and/or apparatus for determining when an ad cache replenishment operation should occur. There is also a need for methods and apparatus for selecting ad data with which to replenish an ad cache when it is determined that an ad cache replenishment operation is to occur.

### SUMMARY

Various embodiments are directed to method and apparatus relating to ad cache maintenance, e.g., determining when ad cache replenishment should occur, replenishing ad cache content and/or updating the content of an ad cache, on a device which supports the presentation of advertisements (ads).

In accordance with one exemplary embodiment, one or more signals are received by a first device including an ad cache from other devices, e.g., devices in the vicinity of the first device. In some embodiments devices are considered to be in the vicinity of the first device if they are in direct peer to peer communication range of the first device allowing their signals to be directly received by the first device. The first device may be a mobile wireless terminal, e.g., telephone or personal assistant device, including an ad cache that stores ads and/or advertisement information. The devices from which signals are received may, and in some embodiments are, other mobile devices and/or advertising devices, sometimes referred to as ad points. Ad points may be associated with individual stores and/or may provide information relating to multiple stores nearby to the ad point. Devices from which signals are received may be within a hundred meters or a few hundred meters of the first device.

Received signals are processed and used to provide information about the context, e.g., information about the surroundings, services available, stores in a region near the transmitting device, etc., in which the first device receiving the signals is in at a given point in time. The set of context information is stored. As new context information is generated from subsequently received signals the newly generated set of context information may be compared to a previously generated and stored set of context information. The comparison operation can be used to detect changes in the context relevant to the first device from a first period of time to which the previously generated set of context information corresponds and the current point or period in time to which the most recently generated set of context information corresponds.

The context associated with the first device may change because of movement of the first device from one location to another or because there are changes in other devices in the area in which the first device is located or other changes such as a change in the services being offered in an area due to a change in the time of day, e.g., lunch may become available at a nearby restaurant or a sporting goods store may close due to the time of day.

An ad cache maintenance operation is performed by the first device based on a generated set of context information. The ad cache maintenance operation in some embodiments involves determining when a change in ad cache content is to be made, e.g., when ad cache content is to be updated with new ad information and/or ads or stale ad information are to be deleted, e.g., as a result of a loss of relevance due to a change in context. The ad cache maintenance operations which may be based on a set of context information may include not only determining when an ad cache maintenance operation is to be performed but may alternatively or in addition be directed to an update operation relating to the updating of the ad cache contents, e.g., by adding new ads and/or ad information to the ad cache.

In embodiments where the generated set of context information is used to trigger an ad cache update operation or to determine how frequently ad cache maintenance operations are to be performed, the amount of change, or a particular type of change in context information, between a recently generated set of context information and a previously generated set of context information can be used as a control factor. A change or change in the rate at which context information changes can, and in some embodiments does, trigger an ad cache update operation or a change in the rate of ad cache update operations. A change in context information such as a store no longer being open or a change in services which are detected to be available in the vicinity of the first wireless device may trigger an ad cache maintenance, e.g., content update, operation and removal of ads which are no longer relevant, from the ad cache.

In some embodiments a rate of change in detected context information is measured and the measurement is expressed in the form of a control value or metric. In at least some such embodiments, as the rate of change in context information increases, the rate at which ad cache maintenance operations, e.g., content update operations, are performed is increased. As the rate at which context information change decreases, as indicated by a decrease in the control value in some embodiments, the rate at which cache maintenance operations are performed is decreased. The rate of ad cache maintenance operations in such an embodiment may be bounded by a minimum time between cache maintenance update operations and a higher maximum time between cache update maintenance operations with the rate or periodicity of cache update operations varying between the minimum and maximum cache update rates.

An ad cache maintenance operation may include downloading new ads and/or ad information and deleting and/or replacing stale ads or ad information. In some embodiments ads are removed from the ad cache after they are displayed on the first device once, or a predetermined number of times, e.g., 2, 3 or 4 times or when context information indicates that the service or item to which the ad relates is no longer available, e.g., within the vicinity or a predetermined distance from the first device. Thus, the number of times an ad is displayed may be limited by the advertiser, and/or an ad is removed from the ad cache when it is unlikely to result in a sale or service being provided.

One aspect is directed to a method of operating a first device including an ad cache including ad data which includes receiving one or more wireless signals from one or more devices in the vicinity of the first device; generating a set of context information from the one or more wireless signals; and performing an ad cache maintenance operation based on said generated set of context information. In some embodiments the wireless signals are discovery signals, e.g., signals communicating information about devices in an area, services available in an area, stores in an area and/or other types of information. In some but not necessarily all embodiments, the ad cache maintenance operation is an ad cache replenishment time determination operation. The ad cache replenishment time determination operation may include determining if said generated set of context information differs from a previously generated set of context information, e.g., a detected change in context information may trigger an ad cache replenishment operation.

In some but not necessarily all embodiments, an ad cache maintenance operation includes storing ad information in the form of metadata corresponding to advertisements selected based on said generated set of context information in said ad cache along with one of i) advertisement content or ii) a pointer to advertisement content. In some embodiments the ad cache maintenance operation includes determining when ad cache replenishment should occur on a device which maintains the ad cache and/or what advertisement data should be loaded in the ad cache on a device, e.g., a first device, when an ad cache replenishment opportunity arises.

In accordance with an aspect, a first device including an ad cache may comprise at least one processor configured to receive one or more wireless signals from one or more devices in the vicinity of the first device, generate a set of context information from the one or more wireless signals; and perform an ad cache maintenance operation based on said generated set of context information. The first device may include a memory coupled to said processor. The memory may include said ad cache.

In accordance with another aspect, a computer program product for use in a first device including an ad cache may include a non-transitory computer readable medium comprising code for causing at least one computer to receive one or more wireless signals from one or more devices in the vicinity of the first device; code for causing the at least one computer to generate a set of context information from the one or more wireless signals; and code for causing the at least one computer to perform an ad cache maintenance operation based on said generated set of context information.

Numerous additional embodiments and benefits are described in the detailed description which follows.

### BRIEF DESCRIPTION OF THE FIGURES

FIG. 1 is a drawing of an exemplary system, in accordance with an exemplary embodiment.

FIG. 2 is a flowchart of an exemplary method of operating a first device including an ad cache, in accordance with an exemplary embodiment.

FIG. 3 illustrates an exemplary first device capable of presenting advertisement, in accordance with an exemplary embodiment.

FIG. 4 is an assembly of modules which may be used in the exemplary first device of FIG. 3.

FIG. 5 illustrates an example where the first device receives wireless signals from different devices at different locations and performs an ad cache maintenance, e.g., ad cache replenishment, operation, in accordance with one exemplary embodiment.

FIG. 6 illustrates an exemplary table including information associated with various advertisement metadata and/or advertisements stored in the ad cache, in accordance with an exemplary embodiment.

### DETAILED DESCRIPTION

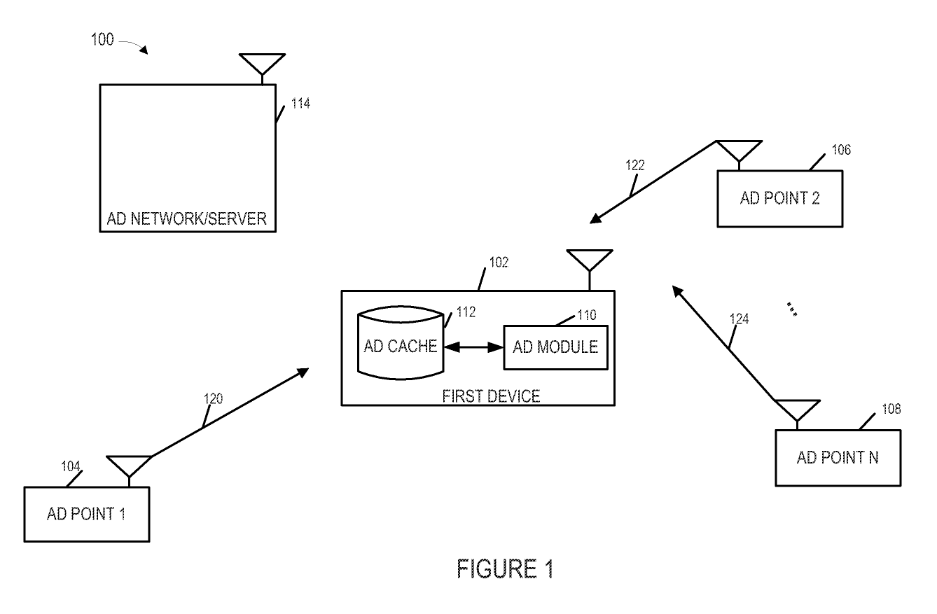

FIG. 1 is a drawing of an exemplary system 100, e.g., a system including communications devices, in accordance with some exemplary embodiments. Exemplary system 100 includes a first device 102 capable of presenting advertisements, one or more other devices, which are sometimes referred to as Ad points, including Ad point 1 104, Ad point 2 106, . . . , and Ad point N 108, and an Ad Network/server 114. The Ad points (Ad point 1 104, Ad point 2 106, . . . , and Ad point N 108) transmit advertisement related information. Although not shown in FIG. 1, it should be appreciated that more than one communications device capable of presenting advertisements may be present in the system 100.

The first device 102 in many embodiments is a mobile device, e.g., a handheld mobile device. In some other embodiments the first device 102 is a stationary device.

The first device 102 includes an ad module 110 and an ad cache 112. The first device 1 102 in various embodiments is capable of receiving signals both wirelessly and using a wired connection. The first device 102 supports peer to peer signaling protocol in addition to other wireless signaling protocols. In some embodiments the first device 102 is a peer to peer communications device. First device 102 can transmit and receive signals, e.g., peer discovery signals and/or traffic data signals, to/from one or more of other devices in the system. The ad cache 112, in some embodiments, includes a plurality of stored advertisements which may be presented, e.g., displayed, to the user of communications device 102 at a presentation opportunity. In some other embodiments the ad cache 112 does not include advertisements, i.e., advertisement content, but rather simply includes advertisement information in the form of advertisement metadata and pointers to the advertisement content. The advertisement content may be stored in the Ad Network 114 from where it can be retrieved by the ad module 110.

The devices, e.g., Ad points (Ad point 1 104, Ad point 2 106, . . . , and Ad point N 108) transmit, e.g., broadcast, wireless signals (shown using arrows 120, 122, 124) communicating information, e.g., advertisement information and/or device discovery information. In some embodiments the wireless signals 120, 122, 124 are device discovery signals. In accordance with one aspect, a communications device such as the first device 102 which is monitoring for the wireless signals and receives the wireless signals from devices in its proximity (e.g., which are in the direct wireless communications range) and uses the information communicated by these wireless signals to generate a set of context information. In accordance with one feature of various embodiments a presentation opportunity corresponds to contexts associated with the presentation opportunity. Thus a presentation opportunity may be associated with a set of contexts. Examples of contexts which may be associated with an advertising opportunity include a profile and/or demographics of the user of the device which presents the advertisement, e.g., user of the first device 102; the set of signals received from other devices (Ad points) that are in proximity to the first device 102; the absolute location of the first device 102; loyalty information of the user of the first device 102; and an application running on the first device 102 associated with the presentation opportunity.

In various embodiments the ad cache 112 includes a set of ad metadata corresponding to one or more advertisements along with either the advertisement content, or a pointer to the advertisement content.

As will be discussed in detail later, in accordance with one aspect the set of context information generated from the received signals is used to perform an ad cache maintenance operation which in some embodiments include, e.g., determining when an ad cache replenishment should occur and what advertisement metadata should be stored in the ad cache 112 of the first device 102.

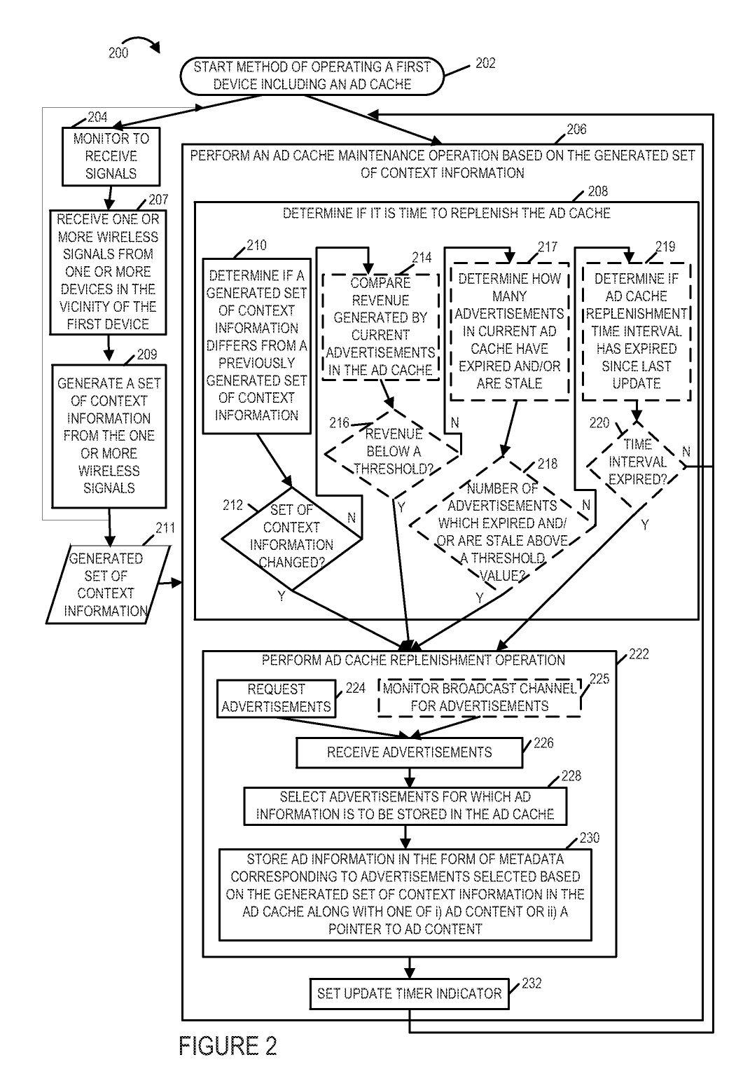

FIG. 2 is a flowchart 200 of an exemplary method of operating a communications device capable of presenting advertisements, in accordance with an exemplary embodiment. The method of flowchart 200 can be, and in some embodiments is, implemented by the first device 102 of system 100 of FIG. 1. As will be discussed, in accordance with one feature of various embodiments, the first device 1 102 receives wireless signal(s) from one or more devices, e.g., Ad points, in the vicinity of the first device 102, and generates a set of context information from the one or more received wireless signals. In accordance with one aspect of various embodiments, the first device 102 performs an ad cache maintenance operation based on the generated set of context information.

The method shown in FIG. 2 starts in step 202, with the first device 102 being powered on and initialized. Operation proceeds from start step 202 to steps 204 and 206 which are performed asynchronously in some embodiments.

In step 204 the first device 102 starts monitoring to receive signals, e.g., wireless signals, transmitted from other devices in the system 100.

Operation proceeds from step 204 to step 207. In step 207 the communications device 1 102 receives one or more wireless signals from one or more devices in the vicinity of the first device 102. In various embodiments the one or more wireless signals are received from devices in the vicinity e.g., direct wireless communications range, of the first device 102. The one or more devices may include, for example, the Ad points 104, 106, 108 shown in the system 100 of FIG. 1. In some embodiments the wireless signals from the one or more devices are peer device discovery signals including, e.g., advertisement information, such as for example, information identifying stores, device and/or services available in an area. The wireless signals may be, e.g., peer discovery expressions that are communicated in a peer to peer discovery channel, WiFi SSIDs, etc. The advertised information is usually associated with a physical entity, e.g., a McDonald's store, a computer repair center, etc., and therefore serves as a meaningful indicator of a user's proximal context at the time the wireless signals communicating the information are received. In accordance with one feature, the Ad Module 110 of the first device 102 collects the expressions and/or discovery information communicated by the wireless signals received by the first device 102 over time.

Operation proceeds from step 207 to step 209. In step 209 the first device 102 generates a set of context information from the one or more received wireless signals, e.g., based on the information communicated by the one or more received wireless signals. Consider an example wherein the first device 102 is near a food court in a mall, e.g., during lunch hours, and receives signals from one or more devices in the proximity, e.g., Ad points, located at food stalls corresponding to different stores such as McDonalds, Pizza Hut, etc. In such a case the received signals from the devices corresponding to these stores are meaningful indicators of the proximal context of the user of the first device 102 at the given point in time when the user is near the food court. The set of context information generated using received signals in such a case may include, e.g., identifiers corresponding to the stores or devices in the food court from which the signals were received, advertisement identifiers for advertisements corresponding to the stores from which the signals were received etc. The proximal content provides a strong indication of what the user of the first device 102 may be interested in at the given point in time.

Other examples of context information which may be associated with the user of the first device 102 include a profile and demographics of the user, absolute location of the first device 102, business loyalty program information corresponding to the user of the first device 102, an application running on the first device 102.

The generated set of context information 211 is produced as an output of step 209. The set of context information 211 serves as an input to step 206. Operation proceeds from step 209 back to step 204. The steps 204 through 209 may be performed on an ongoing basis as the first device 102 detects wireless signals from local devices in the proximity.

Returning to step 206. In step 206 the first device 102 performs an ad cache maintenance operation, e.g., ad cache 112 maintenance operation. The ad cache maintenance operation in some embodiments is performed based on a set of context information, e.g., set of context generated from one or more received signals. Thus in some embodiments the ad cache maintenance operation is triggered by a change in the context information corresponding to the first device 102 at the given time. In some but not necessarily all embodiments the ad cache maintenance operation is performed on a periodic basis even if there has not been any change in the set of context information. In accordance with one aspect, the ad cache maintenance operation is performed so that the advertisement metadata objects cached in the ad cache 112 do not become stale and/or depreciate in value but rather remain current and relevant to the user of the first device 102, e.g., relevant as per a current set of context information. Thus in some embodiments the ad cache maintenance operation includes performing ad cache replenishment operation.

The ad cache 112 includes advertisement metadata corresponding to one or more advertisements. The advertisement metadata corresponding to an advertisement may include one or more of the following: an advertisement identifier identifying an advertisement, descriptive information of advertisement content, information corresponding to an advertiser, store and/or brand to which the advertisement corresponds, a bid price for displaying the corresponding advertisement at a presentation opportunity, a time period during which a corresponding advertisement is available for presentation, time information indicating a time interval for which a corresponding advertisement is valid, geographic location information of stores to which the advertisement corresponds, etc.

The descriptive information includes, e.g., information regarding advertisement content and/or an advertised product. For example the descriptive information may indicate that the corresponding advertisement is for, e.g., a soccer ball, shoes, food item, etc. Information corresponding to an advertiser, store and/or brand indicates that the corresponding advertisement is for, e.g., McDonalds, Starbucks, Nike, etc. The time period information indicates, e.g., a time period of a day during which a corresponding advertisement is available for display.

In various embodiments the ad cache maintenance operation in step 206 is implemented by performing one or more of steps 208, 222 and 232. Step 208 includes determining if it is time to replenish the ad cache 112. In accordance with various embodiments, ad cache replenishment time determination may be made in a number of different ways, if any one or more of which are true, trigger the ad cache replenishment operation. Three different exemplary ways for determining if it is time for ad cache replenishment are shown using the different steps included in step 208. Thus step 208 of performing ad cache time determination operation is implemented by performing one or more of steps 210, 214, 217 and 219. It should be appreciated that the steps shown in dashed boxes show different optional ways of implementing the determining step 208, however all of these optional steps may not necessarily be performed in all embodiments. In one embodiment all four steps 210, 214, 217 and 219 (along with respective decision steps 212, 216, 218, 220 are performed for determining if it is time to replenish ad cache 112.

In step 210 it is determined if a generated set of context information differs from a previously generated set of context information. In various embodiments, for performing ad cache determination the first device 102 uses most recently generated set of context information as it provides a more accurate idea of what the user may be interested in at the given point in time. The previously generated set of context information is often stored in the memory of the first device 102 and is updated when an element in the set of context information changes. Step 210 may include comparing the most recent generated set of context information with the previously generated set of context information. The operation proceeds from step 210 to step 212 where a decision is made based on the operation performed in step 210 determining if the set of context information has changed. A change in context can be detected, for example, when signals from one or more new devices in the proximity of the first device 102 are detected, or when the change in advertisement information communicated by one or more received wireless signals is detected. Such activity indicates a change in context information. If in step 212 it is determined that there has been a change in the set of context information, the ad cache replenishment operation is triggered and the operation proceeds from step 212 to step 222. Thus in some embodiments a difference in one or more physical entities, e.g., new Ad points, indicated to be in the proximity of said first device 102 by said context information triggers ad cache replenishment. If however in step 212 it is determined that there has been no change in the set of context information, the operation proceeds from step 212 to step 214.

In step 214 the first device 102 compares revenue generated by current advertisements in the ad cache 112. The first device 102 maintains an information log including information regarding the performance history of various advertisements which are currently either stored in the ad cache 112 or have advertisement metadata corresponding to them stored in the ad cache 112. The performance history information for each advertisement includes information indicating revenue generated by each of the advertisements. The revenue generated by an advertisement is, e.g., money paid by an advertiser/promoter of the advertisement when the advertisement is presented to the user of the first device 102 and the user selects the advertisement for viewing, e.g., by clicking on the presented advertisement. Thus in step 214 a determination is made to check if the revenue generated by the current advertisements in the ad cache 112 is falling below a certain predetermined threshold value. Operation proceeds from step 214 to step 216 where a determination and decision is made based on the comparison performed in step 214. If it is determined that the revenue generated by the current advertisements is below a threshold value, the ad cache replenishment operation is triggered and the operation proceeds from step 216 to step 222. If it is determined that the revenue generated by the current advertisements is above the threshold value, the operation proceeds from step 216 to step 217.

In step 217 a determination is made regarding how many advertisements in the current ad cache 112 have expired and/or are stale. The operation proceeds from step 217 to step 218 where a comparison and decision is made. In step 218 a comparison is made to determine, if the number of advertisements in the ad cache 112 which have expired and/or are stale, is above a threshold value, e.g., a predetermined limit. If the number of advertisements which have expired and/or are stale is above the threshold limit, the ad cache replenishment operation is triggered and the operation proceeds from step 218 to step 222. In accordance with one feature of some embodiments, ad cache replenishment is triggered when income over time drops below an acceptable threshold. In some embodiments if the revenue goes down, the time before advertisements are declared stale can be, and in some embodiments is, reduced so that more relevant and/or newer advertisements can be cached in the ad cache 112 which may likely increase the revenue. If the comparison in step 218 shows that the number of advertisements which have expired and/or are stale is below the threshold value, the operation proceeds from step 218 to step 219.

In some embodiments ad cache maintenance operation is an ad cache time interval determination operation. Thus in some such embodiments a determination is made if a time interval has expired since the last maintenance, e.g., replenishment, of ad cache. One such way of determining is shown in step 219. In step 219 the first device 102 determines if an ad cache replenishment time interval has expired since last update, e.g., since last replenishment operation. In some embodiments the time interval is a recurring predetermined time period, e.g., 4 hours, after which the ad cache maintenance is performed. The operation proceeds from step 219 to step 220 wherein a decision is made based on determining whether or not the ad cache replenishment time interval has expired. If it is determined that the time interval has expired, this would indicate that it is time to replenish the ad cache 112 and thus the operation proceeds from step 220 to step 222. If however it is determined that the time interval has not expired, this indicates that it is not time yet to perform the ad cache replenishment operation and the operation proceeds from step 220 back to step 206.

In accordance with one feature of some embodiments the ad cache replenishment time interval can be dynamically changed based on a change in the revenue generated by advertisements in the ad cache. For example in one embodiment the ad cache replenishment time interval can be dynamically changed based on change in revenue by, e.g., the ad cache replenishment time interval maybe shortened when advertisement revenue generated by the display of ads drops below a predetermined amount for a given time interval or by a predetermined amount from an amount which was previously being generated from the display of an ad on the device during a time interval. The shortening of the ad replenishment time interval is intended to increase the freshness and hopefully relevance of ads to a device's recent context, thereby potentially increasing the chance that the ad cache will include highly targeted and relevant ads for which the display may generate more revenue. Add replenishment intervals may be increased in cases where revenue from the display of ads reaches goals and/or the more rapid replenishment is determined not to result in an increase in derived ad revenue. Thus, in some embodiments, the ad replenishment time interval is determined dynamically as a function of ad revenue being generated from ads stored in the ad cache. Thus in some embodiments, old/currently stored advertisements in the ad cache 112 can be replaced more frequently if there is a drop in the revenue generated by the advertisements currently stored.

In step 222 an ad cache replenishment operation is performed as part of the maintenance operation. In some embodiments, in order to replenish the ad cache 112 with advertisements, the first device performs one or more of steps 224, 226, 228 and 230. In step 224 the first device 102 sends an advertisement request to an advertisement network, e.g., ad network/server 114, to send advertisements to the first device 102. In some embodiments the advertisement request includes at least some of the context information in the generated set of context information which triggered the ad cache replenishment operation. In some embodiments the advertisement network/server 114 may choose a set of advertisements that are most relevant for the proximity context of the requesting device, e.g., first device 102. That is, the advertisement network/server 114 chooses those advertisements that are most likely to generate revenue when presented to the user of the first device 102, given the user's current proximity context. To perform selection of advertisements for sending to the first device 102, the advertisement network/server 114 may rely upon historic performance of advertisements given proximity contexts, historic performance of similar advertisements, etc. A variety of different advertisement selection methods may be used depending on the particular embodiment. The advertisement network/server 114 may also use a variety of contexts in determining which advertisements (or metadata objects corresponding to advertisements) to return, in which case, it may assign different weights to different types of contexts.

In some embodiments for replenishing ad cache 112, step 225 is performed as an alternative to step 224. In step 225 the first device 102 monitors an advertisement broadcast channel, e.g., a known channel over which advertisers or promoters broadcast advertisements and/or advertisements information, e.g., advertisement metadata.

Operation proceeds from step 224 (or step 225) to step 226. In step 226 the first device 102 receives advertisements. The advertisements are received in some embodiments, e.g., from a broadcast ad source over the advertisement broadcast channel. In some embodiments the advertisements are received from the advertisement network/server 114 in response to the advertisement request.

Operation proceeds from step 226 to step 228. In step 228 the first device 102 selects one or more advertisements for which ad information is to be stored in the ad cache 112. In one embodiment the ad information includes one or more advertisement identifiers (advertisement IDs) identifying advertisement(s) corresponding to, e.g., a store or a brand. It should be appreciated that the first device 102 receives a set of advertisements in step 226 and may be interested in storing, in the ad cache 112, ad information corresponding to only a subset of advertisements which the first device 102 finds relevant based on the set of context information. Thus in step 228 a selection of advertisements is made for which ad information is to be cached in the ad cache 112. As discussed with regard to steps 224 and 225, in some embodiments the ad selection is from a broadcast ad source (e.g., ad channel) or from a set of ads returned in response to an ad request.

Operation proceeds from step 228 to step 230. In step 230 the first device 102 stores ad information, in the form of metadata corresponding to advertisements selected based on the generated set of context information, in the ad cache 112 along with one of i) advertisement content, or ii) a pointer to advertisement content that can be downloaded at a later time. It should be appreciated that the advertisement content may not be stored in the ad cache 112 in all embodiments. In some such embodiments, the metadata corresponding to the selected advertisements may be stored along with a pointer to the advertisement content. The pointer to the advertisement content indicates where the advertisement content is stored and can be retrieved. Accordingly, using the pointer to the advertisement content, the first device 102 can retrieve the advertisement even when the advertisement content is not stored in the ad cache. In some other embodiments the metadata is stored in the ad cache 112 along with the advertisement content corresponding to the selected advertisement. Thus in this manner the ad cache 112 may be replenished with newer and/or more relevant advertisements based on the generated set of context information.

Operation proceeds from step 230 to step 232. In step 232 an update timer indicator is set upon replenishment operation of the ad cache 112, to indicate the time of ad cache replenishment. The update timer indicator is useful for keeping track of the ad cache replenishment time interval. The ad cache replenishment time interval may be a predetermined time interval after which ad cache maintenance operation, e.g., ad cache replenishment, should be performed. In some embodiments using the update timer indicator, first device's system clock, and/or ad cache replenishment time interval information, the first device 102 determines if it is time to perform ad cache maintenance operation. The operation proceeds from step 232 back to step 206. The ad cache maintenance operation step 206 is performed periodically.

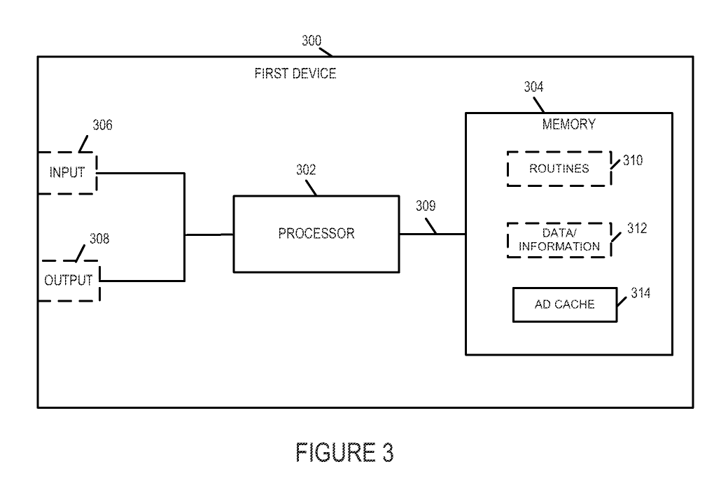

FIG. 3 is a drawing of an exemplary first device 300, e.g., a communications device capable of presenting advertisements, in accordance with an exemplary embodiment. Exemplary first device 300 may be used as the first device 102 of FIG. 1. Exemplary first device 300 may, and sometimes does, implement a method in accordance with flowchart 200 of FIG. 2. In various embodiments the first device 300 is a mobile communications device. In some other embodiments the first device 300 could be a stationary device.

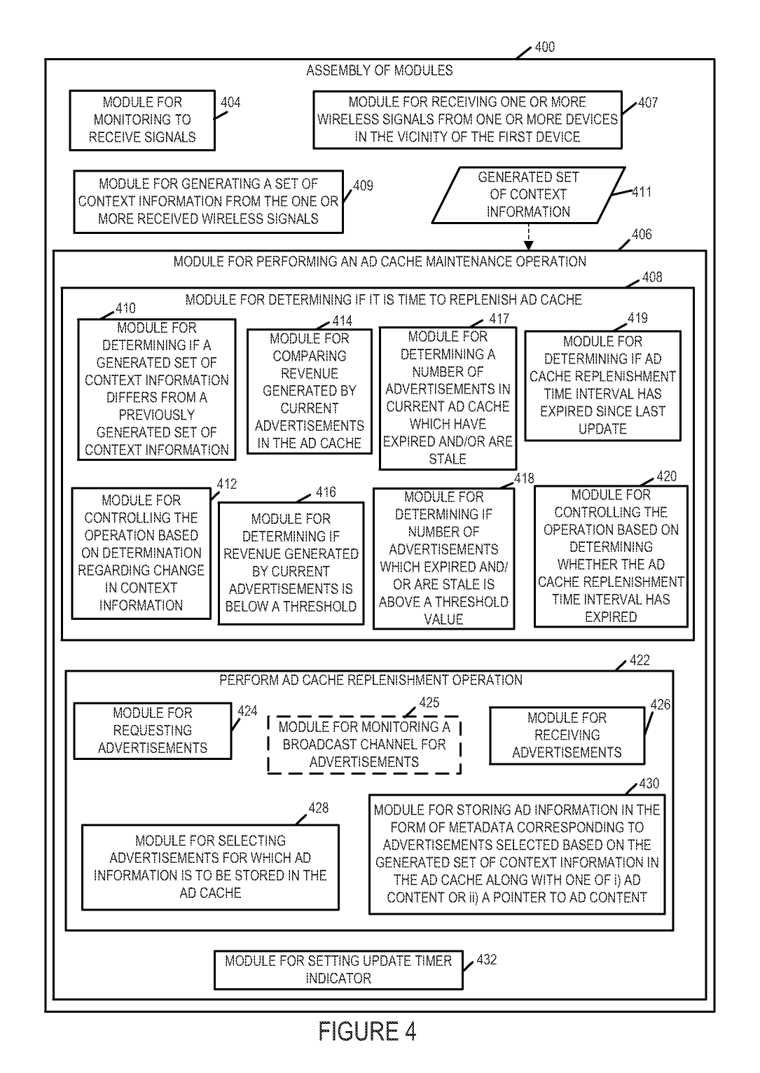

The first device 300 includes a processor 302 and memory 304 coupled together via a bus 309 over which the various elements (302, 304) may interchange data and information. The memory 304 may include an assembly of modules used to control the first device 300, e.g., such as the assembly of modules shown in FIG. 4. The first device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 310 and data/information 312. The memory 304 further includes an ad cache 314 that stores advertisements and/or advertisement information in the form of metadata corresponding to advertisements.

Processor 302 is configured to monitor for signals from one or more devices, receive one or more signals from one or more devices, e.g., Ad points, in the vicinity of the communications device 300, generate a set of context information from the one or more wireless signals, and perform an ad cache maintenance operation based on the generated set of context information. In various embodiments the wireless signals are device discovery signals, e.g., peer to peer discovery signals transmitted during a peer discovery time interval.

In various embodiments the processor 302 is configured to select advertisements for which advertisement information is to be stored in the ad cache of the first communications device 300 as part of performing the ad cache maintenance operation. In some embodiments the advertisement selection is from a broadcast ad source, e.g., an advertisement channel. In some embodiments the processor 302 is further configured to send a request for advertisements to an advertisement network, the request for advertisements including at least some of the context information which triggered the ad maintenance operation. In some such embodiments the processor 302 is configured to select advertisements from a set of advertisements returned in response to the advertisement request.

In various embodiments the processor 302 is further configured to store ad information in the form of metadata corresponding to advertisements selected based on the generated set of context information in said ad cache along with one of i) ad content or ii) a pointer to ad content, as part of performing the ad cache maintenance operation.

In some embodiments the ad cache maintenance operation is an ad cache replenishment time determination operation. In some such embodiments the processor 302 is further configured to determine if said generated set of context information differs from a previously generated set of context information. In such embodiments when is determined that the generated set of context information differs from a previously generated set of context information, the processor 302 is further configured to perform an ad cache replenishment operation. In some embodiments a difference in one or more physical entities indicated to be in the proximity of said communications device 300 by the context information triggers ad cache replenishment. For example, in one embodiment when newer devices are discovered as indicated by a change in the set of context information, ad cache replenishment is triggered and the processor 302 performs the ad cache replenishment operation.

In some embodiments the ad cache maintenance operation is an ad cache replenishment time interval determination operation. In various embodiments the ad cache replenishment time interval determination operation is run periodically at regular intervals. In some such embodiments the processor 302 is further configured to determine if a time interval, e.g., a predetermined time period, has passed since the last maintenance operation, e.g., replenishment, of ad cache. In some such embodiments the processor 302 is further configured to control the operation of communications device 300 based on determining whether or not the ad cache replenishment time interval has expired. In various embodiments, when it is determined that the ad cache replenishment time interval has expired, the processor 302 is further configured to perform the ad cache replenishment operation.

In various embodiments the processor 302 is further configured to determine if it is time to perform an ad cache replenishment operation. In some such embodiments the processor 302 is further configured to compare the revenue generated by the current advertisements in the ad cache over a past period of time to a threshold value. In such embodiments the processor 302 is further configured to perform the ad cache replenishment operation when the comparison indicates that the revenue generated over the past period of time dropped below an acceptable threshold.

In some embodiments, the processor 302 is further configured to determine how many advertisements in the current ad cache have expired and/or are stale, as part of determining if it is time to perform an ad cache replenishment operation. In some such embodiments when it is determined that the number of advertisements in the current ad cache that have expired and/or are stale is above a threshold number, e.g., a predetermined value, the processor 302 is further configured to initiate the ad cache replenishment operation. In various embodiments the processor 302 is further configured to set an update timer indicator after performing an ad cache replenishment operation thereby indicating the time of update, e.g., time of ad cache replenishment.

FIG. 4 illustrates an assembly of modules 400 which can, and in some embodiments is, used in a communications device such as the first device 300 illustrated in FIG. 3. The modules in the assembly 400 can be implemented in hardware within the processor 302 of FIG. 3, e.g., as individual circuits. Alternatively, the modules may be implemented in software and stored in the memory 304 of the communications device 300 shown in FIG. 3. In some such embodiments, the assembly of modules 400 is included in routines 310 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the wireless communications device 300 or elements therein such as the processor 302, to perform the functions of the corresponding steps illustrated and/or described in the method of flowchart 200 of FIG. 2. The assembly of modules 400 includes a module corresponding to each step of the method of flowchart 200 shown in FIG. 2. For example module 404 corresponds to step 204 and is responsible for performing the operation described with regard to step 204.

The assembly of modules 400 includes a module 404 for monitoring to receive signals, a module 407 for receiving one or more wireless signals from one or more devices in the vicinity of the first device 300, a module 409 for generating a set of context information from the one or more wireless signals, the generated set of context information 411, and a module 406 for performing an ad cache maintenance operation. The ad module 110 included in the first device 102 of FIG. 1 can, and in various embodiments is, implemented as module 406, and thus various functions described with regard to the ad module 110 can be performed by the module 406 alone or in combination with one or more other modules in the assembly of modules 400.

In various embodiments the ad cache maintenance operation is performed based on, e.g., the generated set of context information 411 which in an input to the module 406 for performing an ad cache maintenance operation. In some embodiments the ad cache maintenance operation is an ad cache replenishment time determination operation. In various embodiments the module 406 includes a module 408 for determining if it is time to replenish ad cache of the first device 300, and a module 422 for performing ad cache replenishment. In various embodiments the module 408 for determining if it is time to replenish ad cache includes one or more modules for performing various checks to determine whether or not it is time to perform ad cache maintenance, e.g., ad cache replenishment. In various embodiments the module 408 includes a module 410 for determining if the generated set of context information differs from a previously generated set of context information, and a module 412 for controlling the operation (of the first device 300) based on the determination made by module 408 regarding change in context information. In some embodiments a difference in one or more physical entities indicated to be in the proximity of the first device 300 by the context information triggers ad cache replenishment operation.

In some embodiments the module 408 further includes a module 414 for comparing revenue generated by current advertisements in the ad cache of the first device 300 over a past period of time to a threshold value, and a module 416 for determining whether the revenue generated by current advertisements is below a threshold. In various embodiments the module 408 further includes a module 417 for determining how many advertisements in the current ad cache have expired and/or are stale, and a module 418 for determining if the number of advertisements in the current ad cache that have expired and/or are stale is above a threshold number, e.g., a predetermined value.

In some embodiments the ad cache maintenance operation is an ad cache replenishment time interval determination operation and the operation is performed periodically at regular intervals. In some embodiments the module 408 further includes a module 419 for determining if ad cache replenishment time interval, e.g., a predetermined time period, has passed since the last update, e.g., since last ad cache replenishment. In some such embodiments the module 408 further includes a module 420 for controlling the device 300 operation based on determining whether the ad cache replenishment time interval has expired or not.

In various embodiments, module 422 performs the ad cache replenishment operation. Module 422 in various embodiments includes a module 424 for requesting advertisements, e.g., from the advertisement network/server 114, by sending an advertisement request. In some embodiments the module 422 includes a module 425 for monitoring a broadcast channel for advertisements. Thus it should be appreciated that advertisements for ad cache replenishment may be obtained by using either module 424 or module 425, and thus both modules 424 and 425 are not necessarily included in all embodiments. The module 422 further includes a module 426 for receiving advertisements, a module 428 for selecting advertisements for which ad information is to be stored in the ad cache of the first device 300, and a module 430 storing ad information in the form of metadata corresponding to advertisements selected based on the generated set of context information in the ad cache along with one of i) ad content or ii) a pointer to ad content. In various embodiments the assembly of modules 400 further includes a module 432 for setting an update timer indicator. The module 432 sets an update timer indicator each time an ad cache replenishment operation is performed to indicate the time of update, e.g., time of most recent ad cache replenishment.

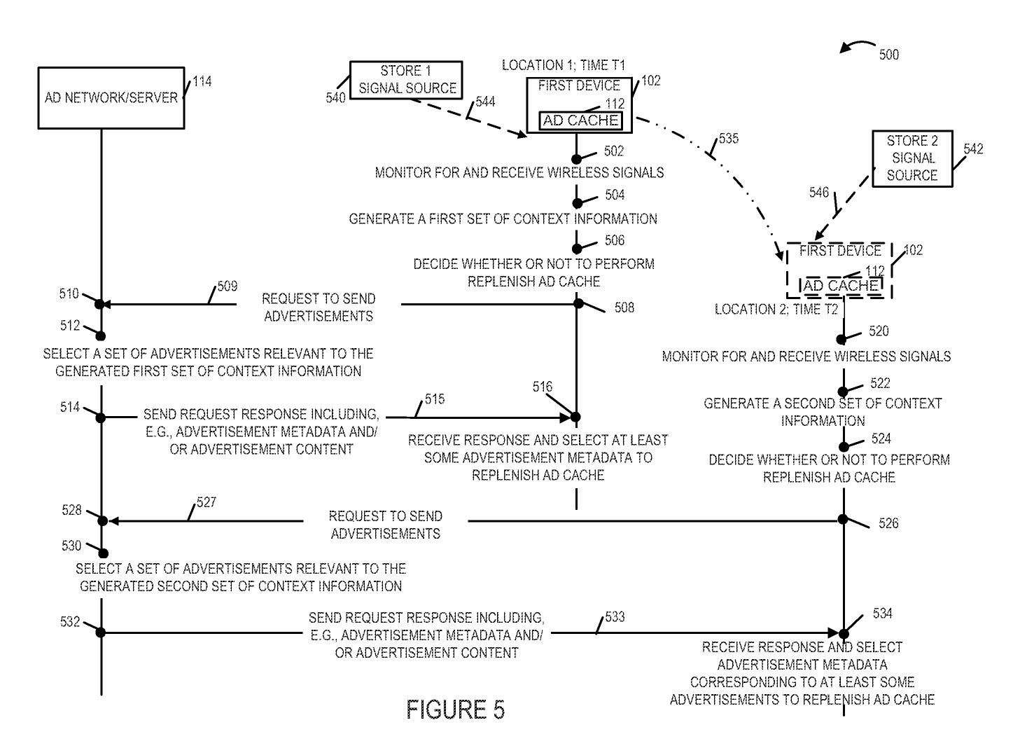

FIG. 5 is a drawing 500 illustrating an example where the first device 102 receives wireless signals from different devices, e.g., Ad points located at different stores, and performs an ad cache maintenance, e.g., ad cache replenishment, operation, in accordance with one exemplary embodiment. The FIG. 5 example illustrates a scenario where the first device 102 receives wireless signals from store 1 signal source 540 (e.g., an Ad point) while the first device 102 is at location 1 at a time T1 and performs one or more steps in accordance with an exemplary method of performing an ad cache replenishment. It is further illustrated in FIG. 5 example that the first device 102 moves from location 1 to location 2 as shown using arrow 535. At location 2 at time T2, the first device 102 receives wireless signals from another device located at store 2, i.e., store 2 signal source 542. It should be appreciated that FIG. 5 merely illustrates an example and a plurality of different variations are possible where ad cache replenishment may be performed in a different way.

In the example of FIG. 5, at time T1 the first device 102 is at location 1, and performs steps associated with an exemplary ad cache replenishment operation. Various steps are represented using reference points on a solid line. Steps (reference points, e.g., 502, 504) which are shown on the solid line correspond to different points in time. For example step 502 is performed earlier than step 504 which is performed earlier than 506 and so on. Solid horizontal arrows represent signals between devices.

The first device 102 monitors for signals from one or more devices and in step 502 receives a wireless signal 544 from, e.g., discovery signals, from the store 1 signal source 540 in the vicinity of the first device 102 at the given time. As discussed with regard to FIG. 2 flowchart, in accordance with one aspect, the first device 102 builds up a set of context from signals received from one or more devices in the proximity. In step 504 the first device 102 builds up such context by generating a first set of context information from the received signal 544. The context information generated from the received signal 544 may include, e.g., proximity context information such as distance to a store and/or ad point; information about a store or promotion; mall store map and/or store layout information, etc. Distance to a store may be estimated from received signal strength when a received signal is transmitted from the store to which the received signal relates. The context information corresponding to a particular device or user can be updated over time.

Next in step 506 the first device 102 decides whether or not to perform an ad cache replenishment operation. This decision can be based on one or more factors. The decision and the factors that influence the decision process have been discussed in greater detail with regard to step 208 (including steps 210, 212, 214, 216, 217, 218, 219, and 220) of FIG. 2, and thus will not be discussed again. For the purpose of this example, consider that the first device 102 decides to perform ad cache replenishment operation.

In step 508 the first device 102 sends an advertisement request (represented by horizontal line 509) to the advertisement network, e.g., ad network/server 114, to send advertisements to the first device 102. In some embodiments the advertisement request includes at least some of the context information from the generated first set of context information. The request 509 is received by the advertisement network 114 in step 510. In step 512 the advertisement network/server 114 selects a set of advertisements that are most relevant for the proximity context of the requesting first device 102. That is, the advertisement network/server 114 chooses those advertisements that are most likely to generate revenue when presented to the user of the first device 102, given the user's current proximity context. The advertisement network/server 114 may also use a variety of contexts in determining which advertisements (or metadata objects corresponding to advertisements) to return, in which case, it may assign different weights to different types of contexts.

In step 514 the advertisement network/server 114 sends a request response signal 515 including advertisement metadata and optionally advertisement content, corresponding to the selected set of advertisements, to the first device 102. In some embodiments the signal 515 does not include the advertisement content, in such embodiments signal 515 includes advertisement metadata along with a pointer to the advertisement content using which the advertisement content may be retrieved by the first device 102 when desired, e.g., at a presentation opportunity. The advertisement content may be stored in the advertisement network/server 114 or an external advertisement database from where the first device 102 may retrieve it. In step 516 the first device 102 receives the request response and selects at least some advertisement metadata (along with the advertisement content if it is included) from the received request response signal 515. The ad cache 112 of the first device 102 is replenished with the selected advertisements metadata and advertisements.

For the purpose of the example discussed in FIG. 5, it is considered that the first device 102 is, e.g., a mobile device, and thus moves from one location to another. The first device 102 moves from location 1 to a different location, i.e., location 2, as shown. On location 2, at a time T2, the first device 102 which monitors for discovery signals from other devices, receives a wireless signal 546 from store 2 signal source 542 in step 520. Following the receipt of signal 546, in step 522 the first device 102 generates a second set of context information from the received signal 546.

In step 524 the first device 102 decides whether or not to perform an ad cache replenishment operation based on one or more factors. For example, the first device 102 determines if there has been a change in the set of context information by comparing the first set of context information and the second set of context information. Since the first set of context information and the second set of context information are generated from different signals received from different physical entities located at two different locations, the comparison shows that there has been a change in the set of context information. As discussed earlier, a change in the set of context information may trigger ad cache replenishment. As should be appreciated, the signal received from a new physical entity serves an indicator of change in the context, e.g., proximity context, of the user of the first device 102. Thus in step 524, it is decided that an ad cache replenishment operation should be performed.

Following the decision, in step 526 the first device 102 sends an advertisement request (represented by horizontal line 527) to the advertisement network, e.g., ad network/server 114, to send advertisements to the first device 102. The advertisement request 527 includes at least some of the context information from the generated second set of context information. The request 527 is received by the advertisement network 114 in step 528. Next, in step 530 the advertisement network/server 114 selects a set of advertisements that are most relevant to the generated second set of context information. The advertisement network/server 114 chooses a set of advertisements that are more relevant for presentation to the user of the first device 102, given the user's current context.

In step 532 the advertisement network/server 114 sends a request response signal 533 including advertisement metadata and optionally advertisement content, corresponding to the selected set of advertisements, to the first device 102. The signal 533 may not necessarily include the advertisement content, rather advertisement metadata along with a pointer to the advertisement content may be included. In step 534 the first device 102 receives the request response 533 and selects at least some advertisement metadata (along with the advertisement content if it is included) from the received request response signal 533. The ad cache 112 of the first device 102 is replenished with the selected advertisements metadata and advertisements. Replenishing the ad cache in some embodiments include replacing at least some previously stored advertisement metadata and/or advertisements with recently selected advertisement metadata and/or advertisements. Thus the first device 102 stores ad information in the form of metadata corresponding to advertisements selected based on the generated second set of context information, in the ad cache 112 along with one of i) advertisement content, or ii) a pointer to advertisement content.

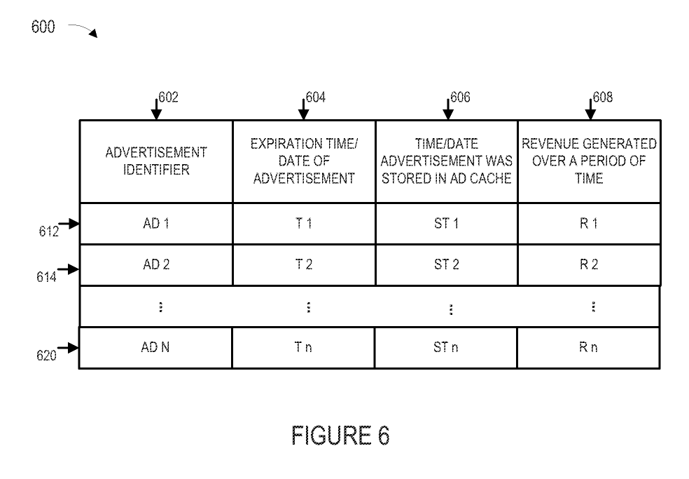

FIG. 6 illustrates an exemplary set of information presented in the form of a table 600 including information associated with various advertisements and/or advertisement metadata stored in the ad cache of the first device 300, in accordance with an exemplary embodiment. The table 600 is maintained by the first device 300, e.g., included as part of memory 304 of first device 300 (102) and is used in some embodiments to control the first device 300 to perform ad cache maintenance operation in accordance with one or more steps discussed in the flowchart 200 of FIG. 2.

The first column 602 in table 600 shows advertisement identifiers identifying various advertisements. The ad cache 314 of the first device 300 includes advertisement metadata corresponding to the various advertisements identified by these advertisement identifiers shown in column 602. The advertisement itself (e.g., advertisement content) may be stored in the ad cache 314 (112) or may be stored in an external database.

The second column 604 shows information regarding expiration time and date corresponding to each of the different advertisements identified by the advertisement identifiers in the corresponding rows. The third column 606 in table 600 shows time and date when each advertisement (or advertisement metadata) identified by the identifier in the corresponding row was stored in the ad cache of the first device 300. Column 608 includes information regarding revenue generated by each of the advertisements identified by the identifiers in the corresponding row. Revenue is generated each time when an advertisement is presented to the user of the first device 102, for example, each time the user clicks on an advertisement to watch.

Consider row 612 corresponding to advertisement identifier AD 1 and the corresponding first entry of each of the columns 604, 606 and 608. The first entry of column 604 indicates that the advertisement corresponding to advertisement identifier AD 1 is set to expire on the date and time shown as T1. The corresponding first entry in column 606 indicates that the advertisement corresponding to advertisement identifier AD 1 was stored on date and time shown as ST 1, while the corresponding entry in column 608 indicates that the advertisement corresponding to advertisement identifier AD 1 has generated revenue R1 so far.

Similarly, consider row 614 corresponding to advertisement identifier AD 2 and the corresponding first entry of each column. The corresponding entry in column 604 indicates that the advertisement corresponding to advertisement identifier AD 1 is set to expire on the date and time shown as T2. The corresponding first entry in column 606 indicates that the advertisement corresponding to advertisement identifier AD 1 was stored on the date and time shown as ST 2, while the corresponding entry in column 608 indicates that the advertisement corresponding to advertisement identifier AD 1 has generated revenue R2 so far. Remaining rows in the table 600 corresponding to different advertisement identifiers may be described in the manner similar to the manner in which rows 612 and 614 have been discussed above.

The information included in the table 600 may be used, for example, when performing one or more steps discussed with regard to the method of flowchart 200. For example, information included in table 600 may be used, among other things, for: (i) comparing revenue generated by current advertisements in the ad cache with a threshold value to determine if the generated revenue has dropped below the threshold value, (ii) determining how many advertisements (or the advertisement metadata corresponding to the advertisements) currently in the ad cache have expired and/or are stale.

Although not shown in FIG. 6, table 600 may also include additional information such as, for example, information indicating total revenue generated over a period of time by all the advertisements corresponding to the advertisement metadata stored in the ad cache 314; information indicating the number of times an advertisement corresponding to an advertisement identifier has been clicked, e.g., selected, for viewing, etc.

From the above discussion it should be appreciated that numerous embodiments are possible. In one particular exemplary embodiment a first device 102 maintains an ad cache 112 that contains advertisement (ad) data, e.g., ad metadata for each advertisement and corresponding advertisement content (also referred to as ad content) or a pointer which can be used to retrieve advertisement content corresponding to the ad metadata. The metadata stored in the ad cache 112 is a subset of metadata for ads available from an advertising system with which the first device 102 interacts. At one or more ad presentation opportunities, e.g., when a presentation opportunity arises, the first device 102 runs an ad selection routine which chooses a subset of ads for which ad metadata is cached, to be presented at the opportunity. The selected subset of ads may include one or more ads for which metadata is stored in the ad cache 112.

In various embodiments the ad selection method implemented by the first device 102, is an auction performed on the first device 102. In one such auction embodiment, one or more ads, for which metadata is cached, that are associated with the highest bids for the context corresponding to the ad presentation opportunity on the first device 102 at the time of the auction are selected for presentation.

In order to maximize ad revenue, it is beneficial that the ads that participate in such a device based auction are highly relevant to the user of the device 102 thereby facilitating high bid prices.

Various embodiments are directed to a mechanism to replenish the ads on a first device 102 using proximity information received by the first device 102 in determining when ad cache replenishment should occur and/or in selecting what ad metadata should be stored in the cache 112 and thereby available for consideration at the time of a device based auction corresponding to a presentation opportunity.

In various embodiments ad metadata is cached in the ad cache 112 maintained the first device 102. The cached data normally includes ad metadata for a plurality of ads and the corresponding ad content or a pointer to the ad content. The ad cache 112 stores a subset of ad data, e.g., because of the limited amount of memory dedicated to ad data storage on the first device, for a subset of the ads available in an advertising system, e.g., an advertisement server, from which the first device 102 receives ad data. While the metadata for ads is cached in the ad cache, the ad content, also referred to as ad payload (e.g., images, videos, etc.), can either be cached or can be retrieved just in time for the presentation opportunity. The ad cache 112 is a cache of metadata objects. It may or may not also serve as a cache of the ads, i.e., the advertisement's content, themselves.

In various embodiments the first device 102 determines when to replenish the ad cache 112 so that the cached advertisement metadata does not become stale or depreciate in value and/or determines what ad metadata to cache, out of the larger set of ad metadata available from the advertising system, in an attempt to maximize the expected revenue for the ad network from ad presentations on that device. In some embodiments, one way to enhance the probability of the relevance of ads, corresponding to cached ad metadata, to a user, is to choose ads based on the proximal context of the user, i.e., the set of entities such as stores, service centers etc., that are near a user at a particular time. For example, a user is more likely to respond to an ad for a retail store (e.g., click it) if the user also happens to be in its proximity. The proximal context is a strong indicator of what a user may be interested in, e.g., at a point in time. The first device 102 is a mobile communications device in some embodiments while in some embodiments the first device 102 could be a fixed, e.g., stationary, device.

In one exemplary embodiment, proximity signals, e.g., peer discovery signals including information identifying stores, device and/or services available in an area are received by the first device 102 from other devices in the proximity of the first device 102. In some embodiments these signals include, e.g., discovery information and/or peer discovery expressions that are communicated in peer to peer discovery channel, WiFi SSIDs, etc. A variety of technologies may be used to transmit and receive expressions, e.g., wireless radio technologies, infrared technologies, etc. Such expressions are usually associated with a physical entity in the real world (e.g., a McDonald's store) and therefore serve as meaningful indicators of a user's proximal context at the time the expression(s) are received.

The first device 102 collects expressions received by the first device over time and selects the most relevant ones for use in ad selection, e.g., for purposes of loading the ad cache 112 as part of a replenishment operation and/or in response to a display opportunity. A variety of policies may, and in some embodiments are, used to determine relevance.

In some embodiments, for the purposes of loading the ad cache 112 as part of a replenishment operation, expressions that indicate a user's habits are selected. Because users are creatures of habit, the user's devices are likely to encounter certain expressions on a regular, predictable basis. These expressions can be deemed relevant to the user. For example, if the first device 102 detects particular expression and/or discovery information for an hour during lunchtime three days a week, it can be inferred that the user frequents the particular location, e.g., a particular restaurant, in a rather predictable manner and the expression is of relevance, e.g., at a given point in time. In some embodiments habit based replenishment of ad cache 112 can be used to optimize power or network usage, e.g., adverts can be given long times before they become stale if it is expected that they will be needed many times over a long time span thus avoiding their repeated download or adverts downloaded for a long time span can have their download delayed until the device is being charged or connected to a low cost network such WiFi.

In some embodiments expressions are selected based on average received power. If the received power is above a certain threshold, the user is likely to be quite proximate to an entity from which the expression has been transmitted, and therefore the user may be more interested in ads related to that entity. For example, a user inside a retail store will detect the store's expression at a high power and may be interested in receiving ads about deals in that store.

In some embodiments expressions are selected based on the duration for which they have been heard. For example, if a user has been at a location for a certain duration, for example, 15 minutes, the first device 102 may determine that various expressions detected at that location are of relevance for the purposes of advertising.

The list of peer discovery expressions filtered by the first device from the set of expressions, e.g., complete set of expressions heard during peer discovery within or over a time period, e.g., a predetermined time period, represents the device's “proximity context” at the time the filtering is performed by the first device. The proximity context is a set of temporally and/or physically relevant expressions.

In some embodiments an ad network/server, such as ad network 114, from which ads may be retrieved keeps state about individual devices, e.g., corresponding to different users, and the devices update the ad network/server 114 of all or some of its proximate context.

In one embodiment when the ad cache 112 in the first device 102 is initialized, it is empty. The device 102 populates the ad cache 112 upon initialization. For this, the device 102 sends an ad request message to an Ad network/server 114. In some embodiments where the context information corresponding to the first device 102 which includes the ad cache 112, is stored in the ad network/server 114, the first device 102 simply includes it's identity or the identity of the first device, e.g., an identifier corresponding to the first device 102, in the ad request message; the ad network 114 uses the identity to retrieve the first device's stored proximal context. In some other embodiments where the context information is not stored in the ad network 114, the first device 102 includes the proximity context to a server in the ad network 114 in conjunction with the ad request. In either case, the first device 102 may also send additional information such as the state of the ad cache and other context information. Alternately, all information about the first device may be known to the ad network via other message exchanges. The request may be sent over a secure channel between the first device 102, and the ad network 114, established by a security protocol such as, e.g., TLS (transport layer security), relying on certificates and/or shared secrets.

In various embodiments the ad network 114 chooses a set of ads that are most relevant for the proximity context of a requesting device, e.g., first device 102. That is, the ad network 114 chooses those ads that are most likely to generate revenue when presented to the user of the requesting device, given the user's current proximity context. In order to perform such selection, in some embodiments the ad network relies upon historic performance of ads given proximity contexts, historic performance of similar ads, historic performance of ads on the requesting device, etc. Any of a variety of ad selection mechanisms maybe used depending on the particular embodiment. The ad network may also use a variety of contexts in determining which ads to return, in which case, it may assign different weights to different types of contexts. The ad network 114 returns ad metadata objects for the chosen ads in a response message to the first device. The first device 102 then populates the ad cache 112 with the returned advertisement data.

After the ad cache 112 is populated, the first device 102 determines, e.g., at various points in time, whether to update the ad cache 112. In various embodiments, different factors trigger ad cache replenishment. Some such factors that trigger ad cache replenishment include:
1. The first device 102 detects a change in the proximity context. This happens, for example, when the first device 102 detects new expressions that are of relevance.
2. The ad metadata for a predetermined number of ads in the ad cache 112 expires. The first device 102 may decide to replenish the ad cache 112 when more than a threshold number of metadata objects have expired.
3. The addition of new ads in the ad network that are of relevance to the first device's proximate context. These will be retrieved as part of replenishment 208, e.g. because they have a different peer discovery expression and replenishment is triggered by 210 and 212 or because other adverts become stale and replenishment is triggered by 217 and 218.
4. The current ads in the ad cache 112 may be underperforming. That is, the revenue generated by the cached set of ads, e.g., over a period of time, may be below a certain threshold. In such situations the first device 102 may replenish the ad cache 112 in order to populate it with ads with a higher performance in the hope of generating greater revenue.

The techniques of various embodiments may be implemented using software, hardware and/or a combination of software and hardware. Various embodiments are directed to apparatus, e.g., communications devices capable of presenting advertisements, which may be mobile or stationary devices, mobile nodes including ad caches such as a mobile wireless terminal including an ad cache, stationary devices including ad cache. Various embodiments are also directed to methods, e.g., method of controlling and/or operating communications devices capable of presenting advertisements which may include a mobile node including an ad cache, a fixed node including an ad cache. Various embodiments are also directed to machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal receiving, processing, generating, selecting, storing, determining, and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more above discussed methods.

In some embodiments, the processor or processors, e.g., CPUs, of one or more devices, e.g., communications devices such as mobile wireless terminals and/or stationary communications devices, are configured to perform the steps of the methods described as being performed by the communications device, e.g., the first device. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a first device, e.g., communications device, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer to peer signaling protocol. While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a first device including an ad cache, comprising:
receiving one or more wireless signals from one or more devices in the vicinity of the first device;
generating a set of context information from the one or more wireless signals; and
performing an ad cache maintenance operation based on said generated set of context information.

2. The method of claim 1, wherein said wireless signals are device discovery signals.

3. The method of claim 1, wherein said ad cache maintenance operation includes:
storing ad information in the form of metadata corresponding to advertisements selected based on said generated set of context information in said ad cache along with one of i) advertisement content or ii) a pointer to advertisement content.

4. The method of claim 1,
wherein said cache maintenance operation is an ad cache replenishment time determination operation; and
wherein said ad cache replenishment time determination operation includes determining if said generated set of context information differs from a previously generated set of context information.

5. The method of claim 4, wherein a difference in one or more physical entities indicated to be in the proximity of said first device by said context information triggers ad cache replenishment.

6. The method of claim 1,
wherein said cache maintenance operation is an ad cache replenishment time interval determination operation; and
wherein said ad cache replenishment time interval determination operation is run periodically at regular intervals.

7. The method of claim 1,
wherein said cache maintenance operation is an ad cache replenishment time determination operation; and
wherein said ad cache replenishment time determination operation includes comparing the revenue generated by the current advertisements in the ad cache over a past period of time to a threshold value.

8. The method of claim 1,
wherein said cache maintenance operation is an ad cache replenishment time determination operation; and
wherein said ad cache replenishment time determination operation includes determining how many advertisements in the current ad cache have expired and/or are stale.

9. A first device including an ad cache, comprising:
means for receiving one or more wireless signals from one or more devices in the vicinity of the first device;
means for generating a set of context information from the one or more wireless signals; and
means for performing an ad cache maintenance operation based on said generated set of context information.

10. The first device of claim 9, wherein said wireless signals are device discovery signals.

11. The first device of claim 9, wherein said means for performing ad cache maintenance operation include:
means for storing ad information in the form of metadata corresponding to advertisements selected based on said generated set of context information in said ad cache along with one of i) advertisement content or ii) a pointer to advertisement content.

12. The first device of claim 9, wherein said means for performing an ad cache maintenance operation include means for determining if it is time to replenish the ad cache by determining if said generated set of context information differs from a previously generated set of context information.

13. The first device of claim 9, wherein said means for performing an ad cache maintenance operation include means for determining an ad cache replenishment time interval, an ad cache replenishment time interval determination operation being performed periodically at regular intervals.

14. The first device of claim 9, wherein said means for performing an ad cache maintenance operation include means for determining ad cache replenishment time by comparing the revenue generated by the current advertisements in the ad cache over a past period of time to a threshold value.

15. The first device of claim 9, wherein said means for performing an ad cache maintenance operation include means for determining ad cache replenishment time by determining how many advertisements in the current ad cache have expired and/or are stale.

16. A first device including an ad cache, comprising:
at least one processor configured to:
receive one or more wireless signals from one or more devices in the vicinity of the first device;
generate a set of context information from the one or more wireless signals; and
perform an ad cache maintenance operation based on said generated set of context information; and
a memory coupled to said at least one processor.

17. The first device of claim 16, wherein said at least one processor is further configured to:
store ad information in the form of metadata corresponding to advertisements selected based on said generated set of context information in said ad cache along with one of i) advertisement content or ii) a pointer to advertisement content.

18. The first device of claim 16, wherein said at least one processor is further configured to:
determine whether it is time to replenish said ad cache; and
determine if said generated set of context information differs from a previously generated set of context information.

19. The first device of claim 16, wherein said at least one processor is further configured to:
determine whether it is time to replenish said ad cache; and
compare the revenue generated by the current advertisements in the ad cache over a past period of time to a threshold value.

20. A computer program product for use in a first device including an ad cache, the computer program product comprising:
a non-transitory computer readable medium comprising:
code for causing at least one computer to receive one or more wireless signals from one or more devices in the vicinity of the first device;
code for causing the at least one computer to generate a set of context information from the one or more wireless signals; and
code for causing the at least one computer to perform an ad cache maintenance operation based on said generated set of context information.
